(19) United States
(12) Patent Application Publication
(10) Pub. No.: US 2004/0197003 A1
(43) Pub. Date: Oct. 7, 2004

(54) Voice coil for loudspeaker and loudspeaker device

(75) Inventors: Toshihiro Ishigaki, Yamamgata-ken (JP); Yutaka Moriyama, Yamamgata-ken (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignees: Pioneer Corporation; Tohoku Pioneer Corporation

(21) Appl. No.: 10/812,001

(22) Filed: Mar. 30, 2004

(30) Foreign Application Priority Data
Mar. 31, 2003 (JP) 2003-94404

(51) Int. Cl. H04R 1/00; H04R 9/06; H04R 11/02

(52) U.S. Cl. 381/400; 381/409

(57) ABSTRACT

A conductor wire comprises a core, a copper-clad layer clad around the core, and an insulating layer provided therearound as required. The core is formed of an alloy of aluminum, magnesium and silicon for flatting with a purity of aluminum greater than or equal to 90%. The copper-clad layer has a cladding rate of 25-40% in an a real ratio. Adoption of the conductor wire provides a voice coil and a loudspeaker device with the same voice coil having excellent waterproof and effective strength.

### BACKGROUND OF THE INVENTION

1. Field of the Invention

The present invention relates to a voice coil for a loudspeaker and a loudspeaker device.

The present application claims priority from Japanese Patent Application No. 2003-094404, the disclosure of which is incorporated herein by reference.

2. Description of the Related Art

A voice coil for a loudspeaker often adopts a conductor wire predominantly including copper as with a typical conductor wire. The adoption of copper, which has a higher specific gravity, weighs down the voice coil itself, resulting in an adverse effect on oscillational characteristics of a loudspeaker, i.e., reduction in characteristics concerning high-tone reproduction. Especially, a voice coil for a high-tone reproducing loudspeaker, i.e., tweeter, adopts an aluminum or aluminum alloy wire having a lower specific gravity and a higher conductivity per unit weight, because the lowest possible weight is desirable for a voice coil of the tweeter. However, there is a problem that exposure to air forms an oxidation layer on aluminum, because aluminum is a chemically active metal. The formation of the oxidation layer makes soldering very difficult. There are also problems that aluminum has a lower tensile strength, poor resistance to bending, and vulnerability to a disconnection due to metal fatigue.

In order to reduce the drawbacks of an aluminum wire, an improved voice coil often adopts a copper-clad aluminum conductor wire including an aluminum or aluminum alloy wire as a core and an outer cladding therearound with copper, as described in:

Page 63 of “Encyclopedia of Loudspeaker & Enclosure (new edition)”, written by SAEKI, Tamon, and edited by Seibundo Shinko-sha, Japan (Apr. 10, 2001); and

Japanese Patent Application Laid-Open No. 2001-271198 A.

As to the copper-clad aluminum conductor wire, which addresses the drawbacks of the aluminum wire as described above, limitation on a ratio of copper cladding can maintain advantages of weight reduction attained by the adoption of aluminum wire. However, in this case, sufficient reliability cannot be attained for loudspeakers in specific uses under hard conditions, as will be described below.

The specific uses, for example, include an application to a vehicle-mounted loudspeaker. When a vehicle is exposed to rain or is washed, water often intrudes into the car. Since aluminum has a property of being readily ionized, the aluminum wire is susceptible to deterioration when it is moistened. In other words, the aluminum wire has a problem concerning waterproof.

In an application to a compact loudspeaker such as a vehicle-mounted loudspeaker, a smaller winding diameter of a coil is inevitably required. In order to attain the smaller winding diameter, the wire should have considerable resistance to bending. However, the copper-clad aluminum conductor wire has poor resistance to bending and vulnerability to a disconnection due to metal fatigue in comparison with a copper wire, because the core of the copper-clad aluminum conductor wire is an aluminum wire. These characteristics indicate disadvantages concerning an application to a compact loudspeaker of the copper-clad aluminum conductor wire. There is another problem that the copper-clad aluminum conductor wire is unfit for a specific application requiring strength, because the copper-clad aluminum conductor wire has a tensile strength stronger than that of the aluminum wire but weaker than that of the copper wire.

### SUMMARY OF THE INVENTION

It is an exemplary object of the present invention to address the above-mentioned problems. That is, the objects of the present invention include providing a voice coil having an excellent waterproof and a sufficient strength while ensuring applicability to high-tone reproduction by virtue of weight reduction, and a loudspeaker device utilizing such a voice coil, or providing a voice coil and a loudspeaker device adequate to vehicle-mounted applications.

In order to accomplish these objects, the present invention comprises elements according to the following configurations.

According to one aspect of the present invention, a voice coil is provided for a loudspeaker, comprising a conductor wire including an alloy of aluminum, magnesium and silicon for flatting with a purity of aluminum greater than or equal to 90%, and copper cladding therearound with an areal ratio of 25-40%.

According to another aspect of the present invention, a loudspeaker device comprises a voice coil formed of a conductor wire including an alloy of aluminum, magnesium and silicon for flatting with a purity of aluminum greater than or equal to 90%, and copper cladding therearound with an areal ratio of 25-40%.

### BRIEF DESCRIPTION OF DRAWINGS

These and other objects and advantages of the present invention will become clear from the following description with reference to the accompanying drawings, wherein:

FIG. 1 illustrates a conductor wire (cross-section) adopted in a voice coil according to the present invention;

FIG. 2 is a graph showing each tensile strength of wires (diameter of 0.20 mm) having a different copper-cladding rate (areal ratio) to a core of an alloy of aluminum, magnesium and silicon;

FIG. 3 illustrates a comparison in each tensile strength between the example according to the present invention and conventional arts;

FIG. 4 illustrates an experimental method for evaluating waterproof;

FIG. 5 is a graph showing each waterproof of wires (diameter of 0.20 mm) having a different copper-cladding rate (areal ratio) to a core of an alloy of aluminum, magnesium and silicon;

FIG. 6 illustrates a comparison of waterproof between the example according to the present invention and conventional arts;

FIG. 7A shows a partial view of a loudspeaker device adopting a voice coil according to an embodiment of the present invention; and

FIG. 7B is a sectional view, taken along A-A of FIG. 7A, of a loudspeaker device adopting a voice coil according to an embodiment of the present invention.

### DETAILED DESCRIPTION OF THE PREFERRED EMBODIMENTS

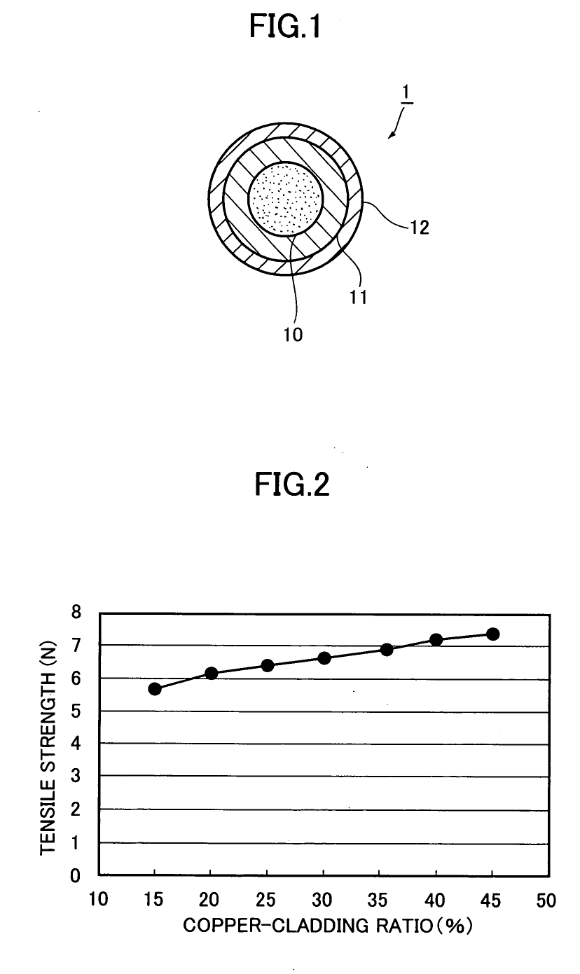

A preferred embodiment of the present invention will be hereinafter described in detail with reference to the accompanying drawings. FIG. 1 illustrates a conductor wire adopted for a voice coil according to the present invention, with a cross-sectional view thereof. A conductor wire 1 comprises a core 10, a copper-clad layer 11 clad around the core 10, and an insulating layer 12 provided at an outermost periphery thereof. The core 10 is made of an alloy of aluminum, magnesium and silicon for flatting having a purity of aluminum greater than or equal to 90%. The cladding rate of the copper-clad layer 11 is set to 25-40% in an areal ratio. The insulating layer 12, for example, comprises an insulating coat of insulating varnish such as polyester, or a fusion coat produced by using alcohol-soluble polyamide resin paint dissolved in organic solvent.

According to the present embodiment, since the alloy of aluminum, magnesium and silicon for flatting has a higher tensile strength and resistance to bending, the wire 1 has higher quality in strength than the conventional copper-clad aluminum conductor wire. If the core 10 has the cladding rate smaller than or equal to 20%, a scratch on the voice coil may reach the core 10, resulting in rust of the core 10 due to moisture. On the other hand, if it has a higher cladding rate of 25-40%, even a deeper scratch would not reach the core 10, thereby increasing waterproof of the voice coil, and applicability to a vehicle-mounted loudspeaker operated with the voice coil being exposed.

With a copper-cladding rate greater than 45%, the specific gravity of the voice coil gets over twice of that in the case with a cladding rate of 0%, prohibiting weight reduction of the voice coil. The voice coil according to the present embodiment limits the copper-cladding rate (areal ratio) to the 25-40% range, ensuring the aforementioned waterproof while attaining weight reduction of the voice coil applicable to high-tone reproduction.

The properties of the voice coil according to the embodiment of the present invention will be hereinafter described in comparison with the conventional art.

(Conductive Properties)

Table 1 shows specific gravities and conductive properties (conductivity, specific resistance) according to the aforementioned core 10 with different copper-cladding rates (copper ratio in areal ratio),

TABLE 1

| | | | | | | | | | | |
|---|---|---|---|---|---|---|---|---|---|---|
| copper ratio | 0 | 5 | 10 | 15 | 20 | 25 | 30 | 35 | 40 | 45 |
| specific gravity | 2.70 | 3.01 | 3.32 | 3.63 | 3.94 | 4.25 | 4.56 | 4.87 | 5.18 | 5.49 |
| conductivity | 58 | 60 | 62 | 64 | 66 | 68 | 70 | 72 | 74 | 76 |
| specific resistance | 2.972 | 2.873 | 2.781 | 2.694 | 2.612 | 2.535 | 2.463 | 2.394 | 2.330 | 2.261 |

wherein each unit for the above items is as follows, copper ratio:

areal ratio %,

specific gravity: g/cm³,

conductivity: %,

specific resistance: 10⁻⁸Ω·m, and

wherein the related information is as follows, specific gravity of copper wire (100% purity of copper): 8.89 g/cm³,

specific resistance of copper wire: 1.724×10⁻⁸Ω·m, and the value of conductivity shows a relative value with respect to 100% of the copper wire.

As apparent in Table 1, the core 10 of the alloy of aluminum, magnesium and silicon and the increased copper-cladding rate (copper ratio in areal ratio) over or equal to 25% can decrease the specific resistance of the conductor wire 1 below 2.554×10⁻⁸Ω·m, which is the specific resistance of the typical copper-clad aluminum conductor wire comprising a core of pure aluminum and 15% of copper-cladding in areal ratio, and having a specific gravity of 3.32 g/cm³ and a conductivity of 67.5%.

(Tensile Strength)

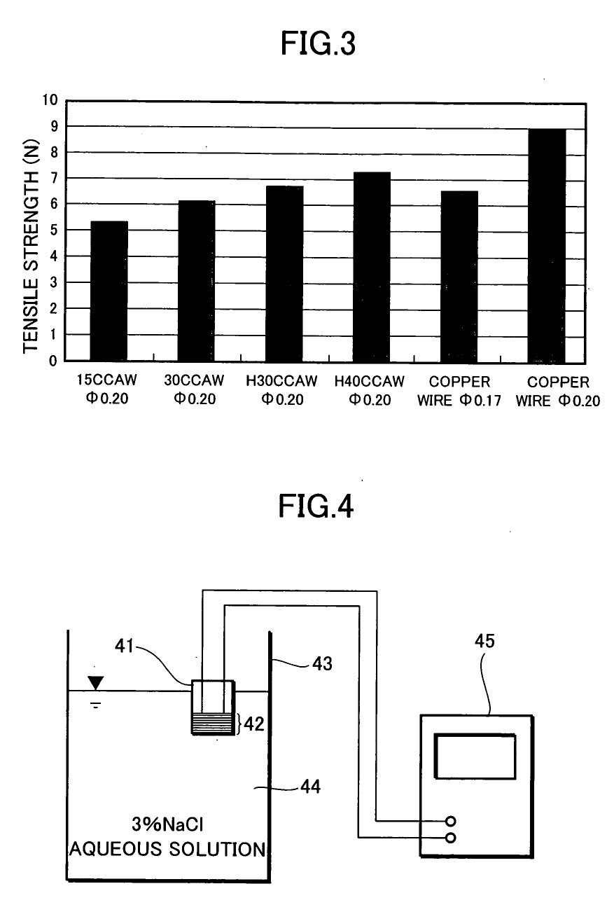

FIG. 2 is a graph showing the respective tensile strengths corresponding to the aforementioned core 10 with different copper-cladding rates (copper ratio in areal ratio), wherein the diameter of the wire is set to 0.2 mm. FIG. 3 illustrates a comparison in tensile strength between the conductor wire for forming the voice coil according to the embodiment of the present invention and that of the conventional art. In the figures, “15CCAW φ 0.20” stands for a conductor wire having a diameter of 0.20 mm and comprising a pure aluminum wire as the core and 15% of copper cladding in areal ratio. “30CCAW φ 0.20” stands for a conductor wire having a diameter of 0.20 mm and comprising a pure aluminum wire as the core and 30% of copper cladding in areal ratio. “H30CCAW φ 0.20” stands for a conductor wire having a diameter of 0.20 mm and comprising a wire of the alloy of aluminum, magnesium and silicon as the core and 30% of copper cladding in areal ratio (example 1). “H40CCAW φ 0.20” stands for a conductor wire having a diameter of 0.20 mm and comprising a wire of the alloy of aluminum, magnesium and silicon as the core and 40% of copper cladding in areal ratio (example 2). “Copper wire φ 0.17” stands for a conductor wire of copper with 100% purity having a diameter of 0.17 mm. “Copper wire φ 0.20” stands for a conductor wire of copper with 100% purity having a diameter of 0.20 mm.

As apparent in these figures, concerning the conductor wire comprising the wire of the alloy of aluminum, magnesium and silicon as the core and the copper cladding, the tensile strength increases as the copper-cladding rate is set to larger value. As apparently shown in the comparison between “H30CCAW φ 0.20” (example 1) and “30CCAW φ 0.20” (conventional copper-clad aluminum conductor wire) in FIG. 3, the conductor wire comprising the wire of the alloy of aluminum, magnesium and silicon as the core and the copper cladding has higher tensile strength than that of the conventional conductor wire comprising the pure aluminum wire and copper cladding, even though the copper-cladding rate is the same.

The following Table 2 shows sensitivities of the loudspeaker comprising voice coils formed with the aforementioned conductor wire. The shown values are the averages of sound pressure levels (dB) outputted from a loudspeaker at 300, 400, 500 and 600 Hz, respectively, having a diameter of 16 cm with 1 W input, and the measurement is made at a position 1 m away from a microphone.

TABLE 2

| | |
|---|---|
| 15CCAW φ 0.20 | 87.24 dB |
| H30CCAW φ 0.20 | 87.22 dB |
| copper wire φ 0.17 | 87.18 dB |

When the copper wire is adopted in order to attain the output sound pressure level to be outputted by the loudspeaker including the voice coil using the conventional copper-clad aluminum conductor wire (15CCAW φ 0.20), the copper wire should be 0.17 mm in diameter. The wire having a diameter of 0.20 and comprising the alloy of aluminum, magnesium and silicon and the copper cladding, at a copper-cladding rate of 25%, exceeds the copper wire having a diameter of 0.17 mm in strength. It should be noted that the wire (H30CCAW φ 0.20) comprising the alloy of aluminum, magnesium and silicon and the copper-cladding with a copper-cladding rate of 30% is not substantially different from the copper wire having a diameter of 0.17 mm in sensitivity of a loudspeaker.

(Waterproof)

FIG. 4 illustrates an experimental method for evaluating waterproof. This experiment includes adopting a conductor wire having a diameter of 0.2 mm, forming a voice coil 42 (winding diameter of 25 mm) with a direct current resistance of 3.2 Ω wound on a bobbin 41 made of a polyimide film, slightly scratching the surface of the voice coil 42 along a vertical direction thereof by a cutter, and immersing the voice coil 42 in a 3% NaCl aqueous solution 44 stored in a container 43 of the voice coil 42. This experiment further includes applying 10 volts to the voice coil 42 using an AC power source 45, and measuring time when a break occurs in the voice coil 42.

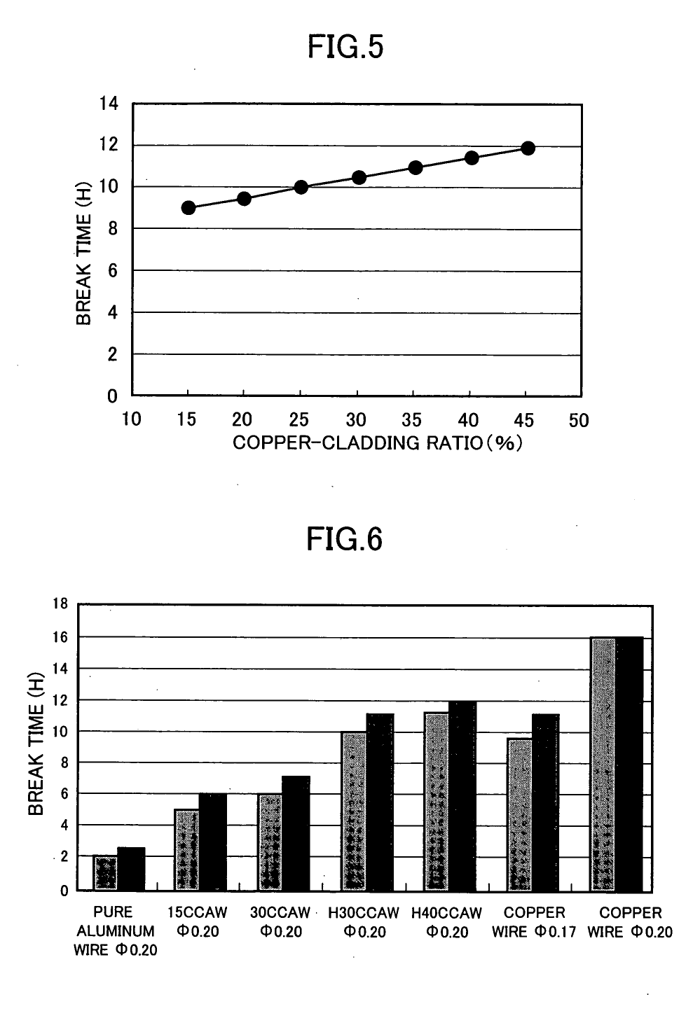

FIG. 5 is a graph showing waterproof of wires (diameter of 0.2 mm) according to the aforementioned core 10 with different copper-cladding rates in areal ratio. As apparent in the figure, the waterproof increases as the copper-cladding rate increases. FIG. 6 illustrates a result of a comparison of waterproof among the aforementioned various conductor wires, the pure copper wires and a pure aluminum wire (diameter of 0.2 mm). The wires each comprising the alloy of aluminum, magnesium and silicon as the core and the copper cladding with a copper-cladding rate over or equal to 25% (H30CCAW φ 0.20, H40CCAW φ 0.20) are significantly improved in waterproof than the conventional copper-clad aluminum conductor wires (15CCAW φ 0.20, 30CCAW φ 0.20), and substantially exhibit waterproof better than or equal to that of the copper wires having a diameter of 0.17 mm.

(Weight of Voice Coil)

The aforementioned conductor wires H30CCAW φ 0.20, H40CCAW φ 0.20 (diameter of 0.2 mm), the copper wire having a diameter of 0.17, and the copper wire having a diameter of 0.20 were utilized to form voice coils (winding diameter of 25 mm) with a direct current resistance of 3.2 Ω on the bobbin made of a polyimide film, and the weight of each voice coil was measured. The results of the measurement are shown in Table 3.

TABLE 3

| | conductor wire | | | |
|---|---|---|---|---|
| | H30CCAW | H40CCAW | copper wire | copper wire |
| diameter (mm) | 0.20 | 0.20 | 0.17 | 0.20 |
| voice coil | 0.855 | 0.987 | 1.102 | 1.891 |
| weight (g) | | | | |

As apparent in Table 3, the voice coils using the wires having a diameter of 0.20 mm and comprising the alloy of aluminum, magnesium and silicon as the cores and the copper cladding with copper-cladding rates of 30% or 40% are lighter in weight than the voice coil using the copper wire having a diameter of 0.17 mm. In addition, an output sound pressure level of a loudspeaker adopting the voice coil using H30CCAW φ 0.20 is 2-3 dB more sensitive than that using the copper wire having a diameter of 0.17 mm in middle-high tone ranges of 5000-15000 Hz (which is measured with 1 m away from a microphone, and under 1 W input)

According to the above properties, the voice coils formed out of respective wires, H30CCAW φ 0.20 and H40CCAW φ 0.20, i.e., examples of the present invention, can be made lighter in weight than that made of the copper wire having a diameter of 0.17 mm, thereby improving the reproduction characteristics of the middle-high tone ranges. The present examples exhibit the tensile strength and waterproof of the voice coil, and the sensitivity of the loudspeaker using the voice coil better than or equal to those of the copper wire having a diameter of 0.17 mm. In other words, the wires according to the present examples enable the voice coils to provide sufficient reliability under hard conditions such as vehicle-mounted situations and high quality in high-tone reproduction, which was insufficient in the conventional copper-clad aluminum conductor wire.

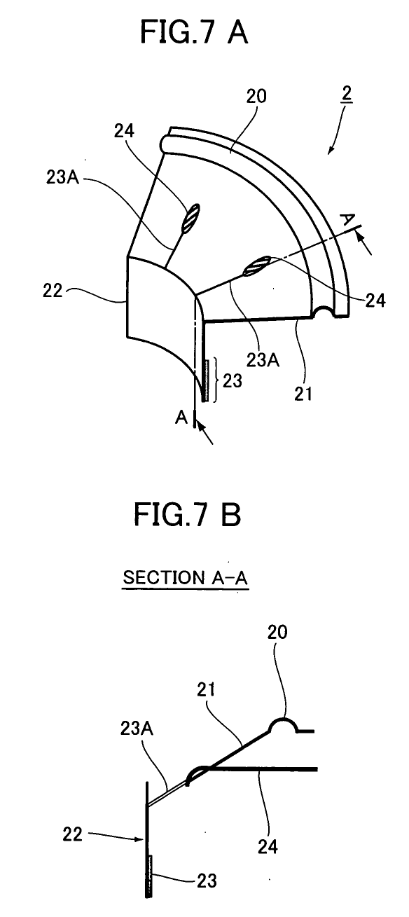

FIG. 7 illustrates a loudspeaker device adopting the voice coil according to the present embodiment. More specifically, FIG. 7A shows a partial view, and FIG. 7B shows a sectional view taken along A-A. In a loudspeaker device 2, a voice coil bobbin 22 is attached to a diaphragm 21 supported via an edge 20. A voice coil 23 is wound on the voice coil bobbin 22. In this case, a conventional method is adopted for drawing out a lead wire. A lead wire 23A from the voice coil 23 is drawn out along the voice coil bobbin 22 and the diaphragm 21, and connected to a lead wire 24 for a loudspeaker.

Concerning the conventional copper-clad aluminum conductor wire (15CCAW φ 0.20), the typical method for drawing a lead wire as described above may break the lead wire due to vibrations of the loudspeaker, rendering the adoption of the typical method inadequate. On the other hand, concerning the voice coil 23 according to the embodiment of the present invention, the increase of the tensile strength allows the aforementioned typical method for drawing a lead wire, thereby attaining cost reduction of the voice coil.

The characteristics of the embodiment of the present invention will be hereinafter summarized. The voice coil for a loudspeaker and the loudspeaker device according to the present invention adopt the voice coil formed out of the wire comprising the alloy of aluminum, magnesium and silicon for flatting, having a purity of aluminum greater than or equal to 90% as the core and the copper-cladding with an areal cladding rate of 25-40%. According to the art, the adoption of the alloy of aluminum, magnesium and silicon for flatting increases the tensile strength and resistance to bending, the assurance of the copper-cladding rate (areal ratio) over or equal to 25% attains improved waterproof, and the assurance of a purity of aluminum of the core over or equal to 90% and the limitation of the copper-cladding rate (areal ratio) under or equal to 40% enable weight reduction suitable for high-tone reproduction. These characteristics provide the voice coil and the loudspeaker device having excellent applicability to hard working conditions such as vehicle-mounted situations, and suitable for high-tone reproduction.

While the presently preferred embodiments of the present invention have been shown and described, it is to be understood that these disclosures are for the purpose of illustration and that various changes and modifications may be made without departing from the scope of the invention as set forth in the appended claims.

What is claimed is:

1. A voice coil for a loudspeaker, comprising:
a conductor wire including an alloy of aluminum, magnesium and silicon for flatting with a purity of aluminum greater than or equal to 90%, and copper cladding therearound with an areal ratio of 25-40%.

2. A loudspeaker device, comprising:
a voice coil formed of a conductor wire including an alloy of aluminum, magnesium and silicon for flatting with a purity of aluminum greater than or equal to 90%, and copper cladding therearound with an areal ratio of 25-40%.
